(19) United States
(12) Patent Application Publication
(10) Pub. No.: US 2026/0042714 A1
(43) Pub. Date: Feb. 12, 2026

(54) HYDROGEL, PARTICULARLY AGAR HYDROGEL, CONTAINING AN EXTRACT OF AT LEAST ONE AGAROPHYTE RED ALGA, METHOD FOR THE PREPARATION THEREOF AND USE THEREOF AS WATER-RETAINING FERTILIZER

(71) Applicant: STE D'ETUDES ET D'EXPLOITATION D'ALGUES ET PRODUITS MARITIME, KENITRA (MA)

(72) Inventors: Mohammed Rachid LEBBAR, KENITRA (MA); Mohamed Salim LEBBAR, KENITRA (MA)

(21) Appl. No.: 19/282,704

(22) Filed: Jul. 28, 2025

(30) Foreign Application Priority Data
Aug. 7, 2024 (FR) FR2408747

(51) Int. Cl. C05G 5/18

(52) U.S. Cl. CPC C05G 5/18

(57) ABSTRACT

Hydrogel based on at least one gelling agent, in particular agar, and containing a product resulting from extraction by an aqueous alkaline solution of at least one agarophyte red alga from the Gelidiaceae family. The hydrogel is advantageously in the form of pieces or blocks, such as balls or cubes.

The present invention concerns an aqueous gel containing an extract of at least one agarophyte red alga, its preparation process and its use as a water-retaining fertilizer.

Hydric stress has become a major and common problem, accentuated by constant climate forecasts which predict more intense hydric stress in the future. To reduce the effects and consequences of hydric stress, crops need water and repeated watering. However, water is lost with each watering, either through evaporation or infiltration into the water table.

Water that is no longer accessible will not be assimilated by cultivated plants, as it is lost. It is estimated that at least 40% of water is lost during watering. This loss is accentuated in arid zones and during the summer season.

Gels capable of capturing the water available to roots are available on the market. It should be pointed out, however, that these well-known hydrogels are generally not authorized for use in food agriculture. In fact, synthetic water-retaining polymers often contain carcinogenic monomers.

The aim of the present invention is to offer a product suitable for use in agriculture for food and biological purposes, to be applied to the base of plants, enabling them to be watered less frequently while increasing their resistance to hydric stress, which can also limit their watering needs.

To this end, the present inventors have succeeded in developing a water-retaining fertilizer formulation in the form of a gel capable of capturing water during its preparation and during watering of the plants to which it is applied, this gel containing water, at least one gelling agent and a liquid fertilizer derived from a agarophyte red alga. The advantage lies in the accessibility of both water and liquid fertilizer to the cultivated plant, which thus boosts its resistance to hydric stress. As shown below, the number of times a crop needs to be watered can be greatly reduced, since water consumption is very low.

Furthermore, thanks to a judicious choice of gelling agent(s), the product has no harmful effects on agriculture, as it is made up mainly of organic matter. When these organic materials degrade, they have no negative consequences. This makes the product safe for use in agronomy, and especially in food agronomy.

The first object of the present invention is therefore a hydrogel based on at least one gelling agent and containing, as a fertilizer, an product resulting from extraction by an aqueous alkaline solution of at least one agarophyte red alga from the Gelidiaceae family.

In particular, the at least one agarophyte red alga of the Gelidiaceae family can be selected from Gelidiella acerosa, Gelidium amansii, Gelidium cartilagineum, Gelidium liatulum, Gelidium pacificum, Gelidium lingulatam, Gelidium sesquipedale, Gelidium corneum and Gelidium pristoides.

In accordance with a particular embodiment, the fertilizing extraction product is the aqueous phase obtained by extracting said at least one red algae by an alkaline aqueous solution, followed by filtration to recover said aqueous phase, which may then have been concentrated, dehydrated or freeze-dried, and then redissolved in water.

In particular, the extraction has been carried out hot, between 4° and 98° C., preferably between 60 and 80° C., for 30 minutes-8 hours, said red alga having been employed at a rate of 600-900 kg in 10-20 m³ of alkaline aqueous solution.

In particular, an aqueous alkaline solution containing 0.1-20% by weight, preferably 1-5% by weight, of sodium hydroxide or potassium hydroxide was used for extraction.

The alkaline aqueous phase obtained after filtration may have been neutralized with an acid, in particular nitric acid, sulfuric acid or phosphoric acid.

The gelling agent(s) can advantageously be chosen from:
agars, in particular agar derived from agarophyte red alga such as those of the Gelidiaceae and Gracilariaceae families;
gelatin;
alginates, such as sodium alginate, in the presence of trivalent or divalent ions, such as calcium ion;
carrageenans, in particular derived from carrageenophyte red alga, such as kappa carrageenan, in the presence of calcium or potassium ions;
pectins, notably derived from fruit skins, in the presence of calcium or barium ions.

Alga from the Gelidiaceae family from which agar is derived can be those already indicated above, and those from the Gracilariaceae family can be chosen from Gracilaria verrucosa and Gracilaria gracilis, for example.

The hydrogel according to the present invention may in particular comprise 0.05 to 100 g, in particular 0.1 to 20 g, of at least one gelling agent per 0.1 to 500 g, preferably 1 to 100 g, of dry extract of the fertilizing extraction product and per 1000 ml of water.

The hydrogel according to the invention can be in the form of pieces or blocks, such as balls or cubes, or in the form of a flowable jelly or viscous mass. The lumpy or blocky form, such as balls or cubes, is particularly interesting for transport and for controlled and regular release of the contained water over time.

Another object of the present invention is a process for manufacturing the hydrogel as defined above, characterized in that the extraction product as defined above is mixed with the gelling agent(s) in an aqueous medium, the mixture is heated to a temperature above the solubilization temperature of the gelling agent(s) and is caused to solidify or form a jelly or viscous mass capable of flowing when cooled, the water coming at least in part from the extraction product.

The heated mixture can be poured either into a mold to obtain, by cooling, a solid molded mass that can be cut into pieces or blocks, such as balls or cubes, or into molds to obtain the pieces or blocks directly, such as balls or cubes.

In accordance with a particular embodiment, the gelling agent used is powdered agar, the mixture is heated to between 50 and 120° C., preferably between 80 and 120° C., for 10 to 20 min, to solubilize the agar, the mixture obtained gelling by cooling the mixture thus heated.

Gelling then takes place via hydrogen bonds at 34-38° C. in the case of agar derived from an alga of the Gelidiaceae family, and at 40-53° C. in the case of agar derived from an alga of the Gracilariaceae family. Once stabilized and in the form of a solid block, agar will only lose its consistency at 80° C.

Another object of the present invention is the agricultural use of hydrogel as defined above or prepared by the process as defined above, as an agent capable of retaining water available to plant roots, while providing a fertilizing effect.

Finally, the object of the present invention is a method of supplying a fertilizer to cultivated plants under conditions of retention of the water used for watering them, in order to reduce or even prevent the loss of water by evaporation or infiltration of the water into the water table, characterized by the fact that the hydrogel as defined above or prepared by the method as defined above is placed on the soil around the plants or in the soil around the plant roots.

The plants are chosen in particular from market garden plants, such as tomatoes, melons, salads such as lettuces, spinach, beans, fruit trees, such as banana trees, avocado trees, pear trees, apple trees, nectarine trees, ornamental plants, horticultural plants, such as rose bushes, meadow plants and field crops.

It is advantageous to apply the hydrogel according to the present invention at a rate of 1 to 5 repetitions throughout the harvesting period, in particular 1 g-10 kg hydrogel/plant, more particularly 10-500 hydrogel/plant.

The following examples illustrate the present invention without, however, limiting its scope.

### EXAMPLE 1: PREPARATION OF A FERTILIZING EXTRACT BY ALKALINE TREATMENT OF GELIDIUM SESQUIPEDALE

800 kg of the red alga Gelidium sesquipedale were placed in 20 m³ of water.

Alkaline treatment was carried out by adding NaOH at 3% concentration by mass at room temperature and stirring for 2 hours.

This was followed by filtration through a 0.1 micron filter to recover the liquid part in a quantity of 19 m³.

This liquid product has a basic pH.

It was neutralized to pH 7 with nitric acid.

### EXAMPLES 2 TO 10: PREPARING WATER-RETAINING FERTILIZING GEL BALLS

The following mixtures were prepared:

| | Volume of neutralized | |
|---|---|---|
| | aqueous extract from | |
| | Ex. 1, at 10% w/v in | Gelling agent Quantity |
| Example | water (mL) | added (g) |
| 2 | 500 | Agar 10 |
| 3 | 500 | Agar 20 |
| 4 | 250 | Agar 10 |
| 5 | 250 | Agar 20 |
| 6 | 125 | Agar 4 |
| 7 | 500 | Gelatin 80 |
| 8 | 500 | Kappa carrageenan 10 |
| 9 | 500 | Pectin* 30 |
| 10 | 50 | Sodium alginate* 10 |

*the mixture was poured into a 2 L calcium chloride bath with 20 g of calcium chloride.

Each mixture was heated for 15 min at boiling point (around 98° C.), then poured into a mold. When the temperature dropped below 35° C., the mixture gelled, and the formula was left to stand for 3 hours.

Hydrogel balls were obtained and subjected to the tests described in the following Examples 7 and 8.

### EXAMPLE 11

In 1 kg pots, we planted lettuces at a rate of 1 plant per pot, with 8 pots per modality.

40 g per pot of the hydrogel balls from Ex 2 to 6 were placed in pots on the soil: 8 pots were used in this example.

40 g/pot of the hydrogel balls from Ex 2 to 6 were placed in pots by being buried 1 cm deep near the roots, 8 pots being used in the case of an example.

8 control pots were provided for examples 2 and 3, 4 and 5, and 6 respectively, which did not receive any hydrogel balls.

Control pots were watered with 50 ml of water per pot every day for 40 days.

All the other pots were watered equally with 50 ml of water per pot, but 1 day out of 2 for the same 40 days.

The masses in grams of lettuce leaves grown during these 40 days are reported in the following Table 1:

TABLE 1

| | | Hydrogel on | | Buried | |
|---|---|---|---|---|---|
| | | surface - Mass | | hydrogel - Mass | |
| | Control - | ex (8 yield | | ex (8 increase | |
| Example | Mass c | increase) | | in yield) | |
| 2 | 4.90 | 8.28 | (69%) | 9.23 | (88.36%) |
| 3 | 4.90 | 9.96 | (103%) | 10.04 | (105%) |
| 4 | 4.39 | 8.23 | (87.47%) | 7.13 | (62.41%) |
| 5 | 4.39 | 7.98 | (81.77%) | 7.80 | (77.67%) |
| 6 | 4.74 | 6.77 | (42.83%) | 5.57 | (17.5%) |

The percentage increase in yield is defined as the ratio

$$( Mass ex - Mass c ) / Mass c * 100$$

For each of Examples 2 to 6, an increase in yield is observed despite a 50% reduction in watering.

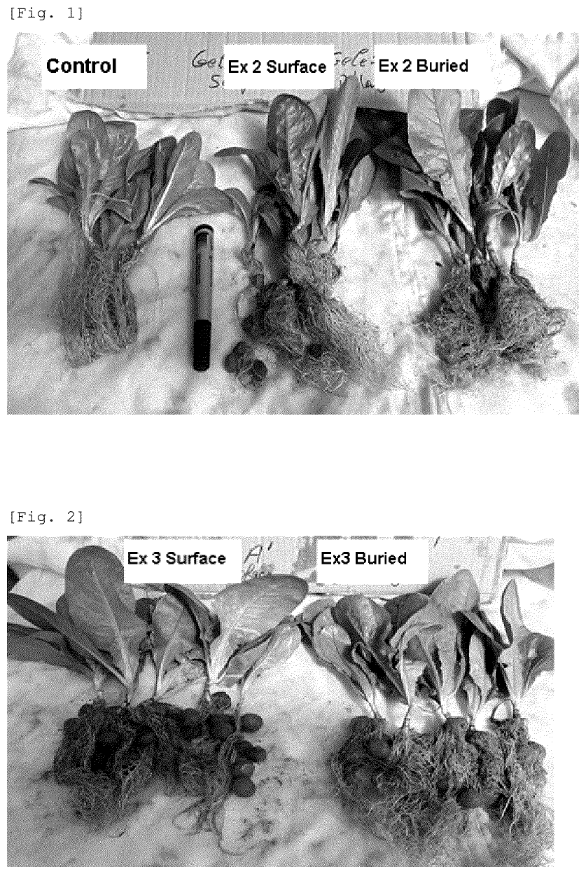

FIG. 1 shows lettuce plants from the control and Example 2 with their roots removed from the soil after treatment.

FIG. 2 shows lettuce plants from the control and Example 3 with their roots removed from the soil after treatment.

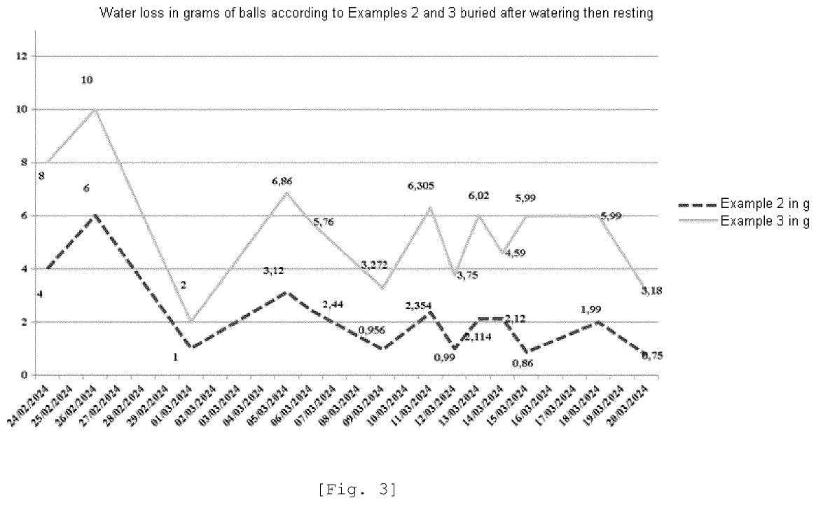

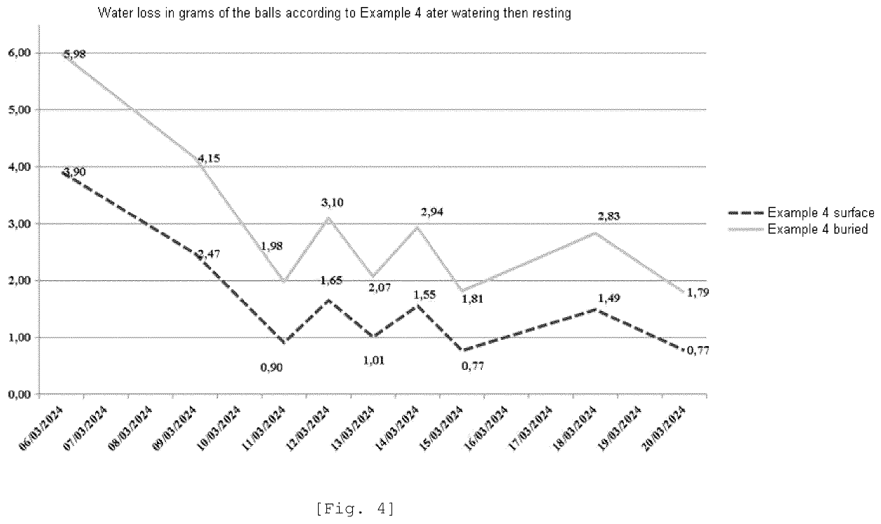

FIG. 3 shows the water loss in grams of the buried balls in Examples 2 and 3 after watering and resting.

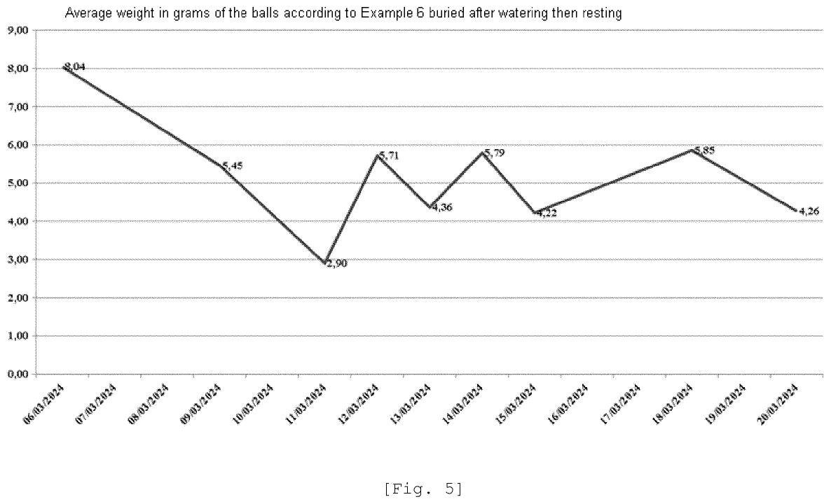

FIG. 4 shows the water loss in grams of the balls in Example 4 after watering and resting.

FIG. 5 shows the average weight in grams of the buried balls in Example 6 after watering and resting.

It can be seen from these figures that both the surface (above-ground) and buried hydrogel balls in Examples 2 and 3 are penetrated by the lettuce roots, while the buried hydrogel balls are penetrated to a greater extent by the roots. Fertilizer extract and water are more accessible to the plants in the buried case than in the surface case.

Parallel monitoring of gel ball mass was carried out on hydrogel balls that were watered and then left to stand. The procedure was as follows: the balls were placed on a filter, the water escaping by syneresis was filtered, collected in a graduated beaker and measured; in parallel, the mass of the balls was measured. The results are shown in FIGS. 3, 4 and 5.

A gain in weight during watering has been observed, showing that the balls absorb part of the water used for watering and then gradually release it. It is possible to capture and save water from several watering sessions, and to keep this water available to plants over an extended period.

### EXAMPLE 12

We proceeded as in Example 11 except that we used the hydrogel balls according to Examples 2 and 3 with the application of 8 g of balls instead of 40 g of balls. The control was watered every day for 21 days and the other pots only once during these 21 days.

The results are reported in Table 2 below:

TABLE 2

| | Control - | Mass ex | |
|---|---|---|---|
| Example | Mass t | (% increase in yield) | |
| 2 | 11.13 | 21.39 | (92%) |
| 3 | 11.13 | 21.58 | (93.89%) |

An increase in yields comparable to those observed in Example 11 is observed with a lower quantity of hydrogel balls, i.e. 8 g instead of 40 g. Also, despite greater hydric stress, i.e. only 1 watering in 21 days, yields are improved for lettuces that received hydrogel balls compared with the control, which was watered every day for 21 days.

1.-16. (canceled)

17. Hydrogel which is based on at least one gelling agent and which contains, as fertilizer, a product resulting from extraction by an aqueous alkaline solution of at least one agarophyte red alga of the Gelidiaceae family.

18. Hydrogel according to claim 17, wherein the at least one agarophyte red alga of the Gelidiaceae family are selected from Gelidiella acerosa, Gelidium amansii, Gelidium cartilagineum, Gelidium liatulum, Gelidium pacificum, Gelidium lingulatam, Gelidium sesquipedale, Gelidium corneum and Gelidium pristoides.

19. Hydrogel according to claim 17, wherein the fertilizing extraction product is the aqueous phase obtained by extraction of the at least one red alga by an alkaline aqueous solution or followed by filtration to recover said aqueous phase, which may then have been concentrated, dehydrated or freeze-dried, and then redissolved in water.

20. Hydrogel according to claim 19, wherein the extraction was carried out hot, between 4° and 98° C., for 30 minutes-8 hours, the red alga having been employed in an amount of 600-900 kg in 10-20 m³ of alkaline aqueous solution.

21. Hydrogel according to claim 19, wherein an aqueous alkaline solution of 0.1-20 wt. %, sodium hydroxide or potassium hydroxide was used for extraction.

22. Hydrogel according to claim 19, wherein the alkaline aqueous phase obtained after filtration has been neutralized with an acid.

23. Hydrogel according to claim 17, wherein the at least one gelling agent is selected from:
agars;
gelatin;
alginates, in the presence of trivalent or divalent ions;
carrageenans, in the presence of calcium or potassium ions;
pectins, in the presence of calcium or barium ions.

24. Hydrogel according to claim 23, wherein:
the agars are chosen from agar derived from agarophyte red alga of the Gelidiaceae and Gracilariaceae families;
the alginate is sodium alginate and the trivalent or divalent ions are calcium ion;
the carrageenans are derived from red carrageenophyte alga;
the pectins are derived from fruit skins.

25. Hydrogel according to claim 17, wherein the hydrogel comprises 0.05 to 100 g of at least one gelling agent per 0.1 to 500 g of dry extract of the fertilizing extraction product and per 1000 mL of water.

26. Hydrogel according to claim 17, wherein the hydrogel is in the form of pieces or blocks or in the form of a flowable jelly or viscous mass.

27. Process for manufacturing the hydrogel as defined in claim 17, wherein the extraction product as defined in claim 17 is mixed with the gelling agent(s) in an aqueous medium, the mixture is heated to a temperature above the solubilization temperature of the gelling agent(s) and is caused to solidify or form a jelly or viscous mass capable of flowing when cooled, the water coming at least in part from the extraction product.

28. Process according to claim 31, wherein the heated mixture is poured into a mold to obtain a block which can be cut into pieces or blocks, or into molds to obtain the pieces or blocks directly.

29. Process according to claim 26, wherein the gelling agent used is powdered agar, the mixture is heated to between 5° and 120° C. for 10 to 20 min, to solubilize the agar, the mixture obtained gelling by cooling the mixture thus heated.

30. A process of supplying a fertilizer to cultivated plants under conditions of retention of the water used for watering them in order to reduce or even prevent the loss of water by evaporation or infiltration of the water into the water table, wherein the hydrogel as defined in claim 17 is arranged on the soil around the plants or in the soil around the plant roots.

31. Process according to claim 30, wherein the plants are selected from market garden plants, salads, spinach, beans, fruit trees, ornamental plants, horticultural plants, meadow plants and field crops.

32. Process according to claim 31, wherein the market garden plants are selected from tomatoes and melons, the salads are lettuces, the fruit trees are selected from banana trees, avocado trees, pear trees, apple trees, nectarine trees, the horticultural plants are rose bushes.

33. Process according to claim 30, wherein the hydrogel is applied at a rate of 1 to 5 repetitions throughout the harvesting period, in particular 1 g-10 kg hydrogel/plant, more particularly 10 g-500 g hydrogel/plant.
